(19) United States
(12) Patent Application Publication
(10) Pub. No.: US 2012/0250985 A1
(43) Pub. Date: Oct. 4, 2012

(54) Context Constraints for Correcting Mis-Detection of Text Contents in Scanned Images

(76) Inventor: Jing Xiao, Cupertino, CA (US)

(21) Appl. No.: 13/076,026

(22) Filed: Mar. 30, 2011

(51) Int. Cl. G06K 9/34

(52) U.S. Cl. 382/164; 382/176

(57) ABSTRACT

Misclassified text components are identified and corrected by comparing non-text components with their neighboring text components. If a non-text component being examined is found to be substantially aligned with its neighboring text components, and is further found to have a similar average color and size as its neighboring text components, then it is reclassified as a text component. Misclassified non-text components are reduced by restricting text labeling to areas of a document image defined by an edge map. The edge map is made by smoothing the document image, and applying edge detection to the smooth image.

### BACKGROUND

1. Field of Invention

The present invention relates to identification of text components and non-text components in an image document, such as implemented in optical character recognition applications.

2. Description of Related Art

Optical character recognition, or OCR, is a broad term applied to the general field of using machines to recognize human-readable glyphs, such as alphanumeric text characters and Chinese written characters, or more generally, Asian written characters. There are many approaches to optical character recognition, such as discussed in U.S. Pat. No. 5,212,741. However, an integral part of the field of OCR is a step to first identify, i.e. classify, pixels of an image as text pixels or non-text pixels. Typically, a collection of text pixels may be termed a text component, and a collection of non-text pixels may be termed a non-text component. Text pixels may then be further processed to identify specific text characters, such as Western text characters or Asian writing characters.

Each image pixel may be classified individually as a text pixel or a non-text pixel. Although it is possible to process an entire image document at once, one may alternatively define image regions (i.e. specifically shaped regions, such as rectangles) within the image document, and process the groups of pixels bounded within it.

In either case, on typically ventures to identify foreground pixels, and limit the classification process to the foreground pixels. For example, if image regions are used, then the foreground pixels within the image regions may be identified and a connected components structure (i.e. CC structure) of connected foreground pixels identified. The pixels defined by the CC structure are candidate pixels that may then be processed for classification as text pixels or non-text pixels.

Various approaches to distinguishing text regions from non-text regions of an image have also been proposed. For example, U.S. Pat. No. 6,038,527 suggests searching a document image for word-shape patterns to identify text regions. Once the text regions are identified, the pixels that are deemed to be part of human-readable glyphs (herein after generically identified as “text”) may be labeled text pixels. These pixels may then be further processed to identify the specific text character of which they are a part.

The process of identifying text regions, and the subsequent task of identifying text pixels, is complicated when an image document being processed has a mixture of text and non-text representations. That is, if the image includes photo pictures or line illustrations, it is possible that some of these non-text regions may be erroneously identified as text region, resulting in the misclassification of text pixels. At best, this slows down the overall process since non-text pixels are processed for text identification only to be rejected as non-text. At worst, processing of the misclassified text pixels may result in they being wrongly identified true text characters, resulting in a human-discernable error in the output.

This misclassification error is exacerbated in scanned documents. Text regions are typically restricted to foreground regions of an image, and thus an initial step to pixel classification is to separate the foreground from the background in a scanned document. Connected-component, CC, operations are then conducted on the foreground pixels to identify candidate component (i.e. candidate pixels) for classification. Unfortunately, scanned documents typically develop artifacts throughout the scanned document, including within background areas. These artifacts appear as intentional markings within a background area and thus can be mistakenly identified as foreground pixels.

This issue is particularly acute in printed documents having colorful backgrounds and patterns, where halftone textures that are part of the printing process may show up as artifacts in its scanned representation. The artifacts cause the background to not be smooth or homogeneous leading to the artifacts being erroneously identified as foreground pixels subject to CC operations. Thus, the artifacts tend to become candidate pixels, at best, or erroneously identified as text characters, at worse.

What is needed is method of minimizing the misclassification of photo pixels, line drawing pixels, etc. as text pixels.

Also needed is a method of double checking classified text pixels for possible misclassification.

### SUMMARY OF INVENTION

The above objects are met in a method of identifying text components within a document image, the method having the following steps: (a) submitting the document image to a text labeling process to define connected components of foreground pixels within at least a region of the document image and to assign the connected components an initial classification of text component or non-text component as determined by the text labeling process; (b) for each non-text component, defining a neighborhood region around the non-text component, where text components within the neighborhood region are termed neighboring text components; IF there is a predefined number of neighboring text-components, THEN IF the non-text component meets a predefined set of criteria comparing the non-text component to its neighboring text-components, THEN reclassifying the non-text component as a text component; ELSE maintaining the non-text component's classification of non-text.

Preferably, the neighborhood region is defined as an area extending within a predefined multiple of the area of the non-text component's bounding block. This predefined multiple may be 2.

Additionally, the set of predefine criteria includes: determining if the non-text component's bounding block is aligned with the bounding blocks of its neighboring text components within a predefined margin of error. In this case, the margin of error is 40% of the dimensions of the non-text component's bounding block.

In one embodiment, the predefined number is two.

Further preferably, the set of predefine criteria includes: determining if all the neighboring text components have an average color matching the average color of the non-text component within 40%, and if all the bounding blocks of all the neighboring text components having a size within ±40% of the non-text component's bounding block.

Furthermore in the step (a), the text labeling process is applied only to areas of the document image coinciding to an edge neighborhood defined as areas of the document image corresponding to a local neighborhood of an edge map.

In this case, the edge map is defined by: (i) smoothing the document image to create a smooth document image; and (ii) applying edge detection to the smoothed document image, the resultant detected edges being the edge map.

Preferably, the local neighborhood is the area within ±20 pixels of the smoothed edges of the edge map. Also within in step (i), the document image is preferably smoothed by application of a Gaussian filter.

If desired, a density filter process may be applied to the document image after step (a) and prior to step (b), wherein the density filter process includes: (A) determining if a text component that is not bigger than a predefined size can be identified, the identified text component being termed a candidate half-tone component; (B) IF no candidate half-tone component is identified, then ending the density filter process; ELSE defining a local neighborhood of minimum size surrounding the candidate half-tone component; identifying any additional text component within the local neighborhood that are not bigger than the predefined size; and IF the percentage of text pixels within the local neighborhood is greater than a predefine percentage and the number of text components that are not bigger than the predefined size within the local neighborhood is greater than a predefined minimum number, THEN reclassify all text components within the local window as non-text components; (C) returning to step (A). Preferably, the minimum size of the local neighborhood is three times the area of the candidate half-tone component's bounding box or a 30×30 pixel area, which ever is greater; the predefine percentage 50%; and said minimum number is 4.

The above objects are also met in a method of identifying text components within a document image, the method having: (i) smoothing the document image to create a smooth document image; (ii) defining an edge map by applying edge detection to the smoothed document image; and (iii) submitting select areas of the document image to a text labeling process to assign an initial classification of text component or non-text component to connected components of foreground pixels, wherein the selected areas are defined as coinciding to a local edge neighborhood of the edge map.

In this case, the local edge neighborhood is the vicinity defined within ±20 pixels of the smoothed edges of the edge map.

Additionally in step (i), the document image may be smoothed by application of a Gaussian filter.

Preferably, this embodiment further includes: (iv) for each non-text component, defining a neighborhood region around the non-text component, where text components within the neighborhood region are termed neighboring text components; IF there are at least two neighboring text-components, THEN IF the non-text component meets a predefined set of criteria comparing the non-text component to its neighboring text-components, THEN reclassifying the non-text component as a text component; ELSE maintaining the non-text component's initial classification.

In this case, the neighborhood region is defined as an area extending within two times the area of the non-text component's bounding block.

Additionally, the set of predefine criteria may include: determining if the non-text component's bounding block is aligned with the bounding blocks of its neighboring text components within a predefined margin of error. In this case, the margin of error is preferably 40% of the dimensions of the non-text component's bounding block.

If desired, the set of predefine criteria may include determining if all the neighboring text components have an average color matching the average color of the non-text component within 40%, and if all the bounding blocks of all the neighboring text components having a size within ±40% of the non-text component's bounding block.

Other objects and attainments together with a fuller understanding of the invention will become apparent and appreciated by referring to the following description and claims taken in conjunction with the accompanying drawings.

### BRIEF DESCRIPTION OF THE DRAWINGS

In the drawings wherein like reference symbols refer to like parts.

FIGS. 1A to 1E illustrate an example of Label Aided Copy Enhanced pixel labeling.

FIGS. 2A and 2B illustrate the reclassification of mislabeled text components in accord with the present invention.

FIG. 3 illustrates two examples of misclassified non-text components due to half-tone error.

FIG. 4 shows the results of using density filtering to reduce half-tone error.

FIGS. 5A and 5B show five examples of document images with half-tone error.

FIG. 6 illustrates the smoothing of an original document image in a first step for correcting half-tone error in accord with the present invention.

FIG. 7 illustrates the creation of an edge map from the smooth image of FIG. 6, as a second step for correcting half-tone error in accord with the present invention.

FIG. 8 illustrates the results of applying the half-tone correction method in accord with the present invention to the images of FIGS. 5A.

FIG. 9 illustrates the results of applying the half-tone correction method in accord with the present invention to the images of FIGS. 5B.

### DESCRIPTION OF THE PREFERRED EMBODIMENTS

The present invention is suitable for use with various methods of content text detection in an image document, such as a scanned document. That is, it is suitable for use with various method of classifying (i.e. labeling) pixels as text pixels (i.e. pixels that are part of human-readable glyphs) or non-text pixels (i.e. pixels that are not part of human-readable glyphs). For terms of discussion, a connected-component collection of text pixels is hereinafter termed a text component, and a connected-component collection of non-text pixels is hereinafter termed a non-text component. Additionally, a component bounding block refers to the smallest rectangular box that can completely enclose a component (i.e. a text component or a non-text component).

The present invention addresses the problem of the misclassification of text pixels as non-text pixels, and the misclassification of non-text pixels as text pixels. To provide a reference of discussion, the initial steps of a method making an initial classification of text pixels is provided. It is to be understood that the specific method used for the initial classification of components (or pixels) as “text” or “non-text” is not critical to the invention.

A preferred method for identifying text pixels is the Label Aided Copy Enhanced (i.e., LACE) method as described in U.S. Pat. No. 7,557,963 (AP229TP), assigned to the same assignee as the present invention, and herein incorporated in its entirety by reference. The LACE method provides a pixel-labeling (or component labeling) method with high position accuracy. It uses image gradients to classify image pixels with one of five LACE labels: a halftone label; a strong edge in a halftone region label; a strong edge in non-halftone region label; a non-halftone label; and a background label.

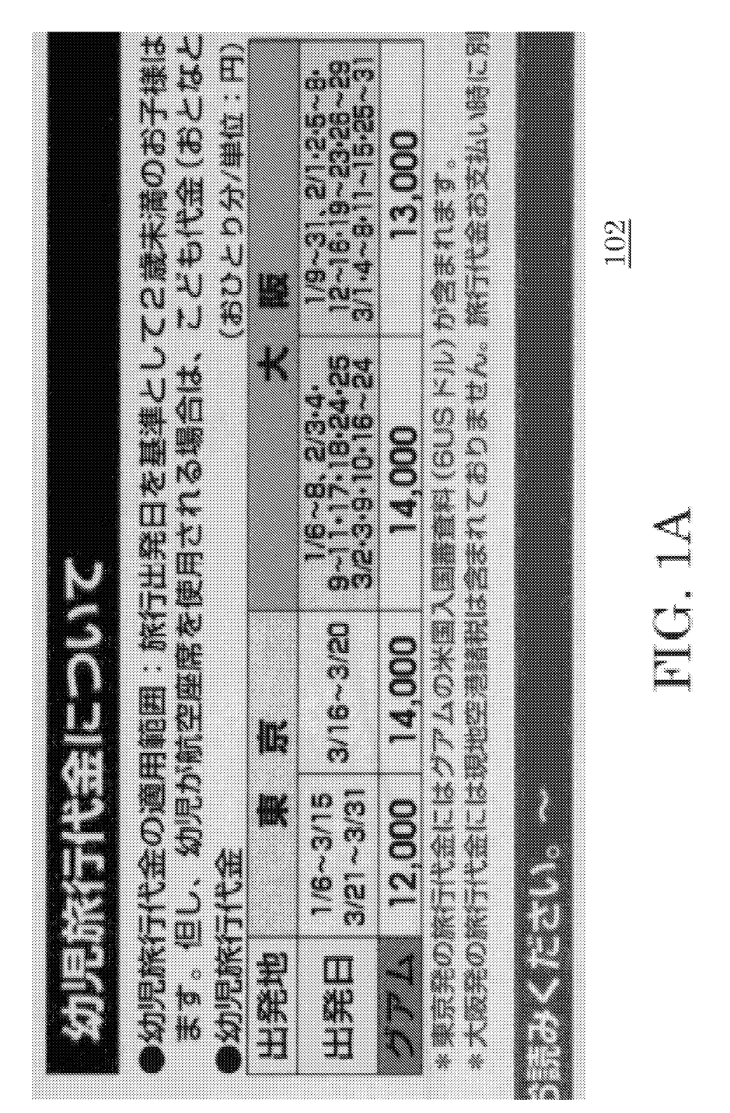

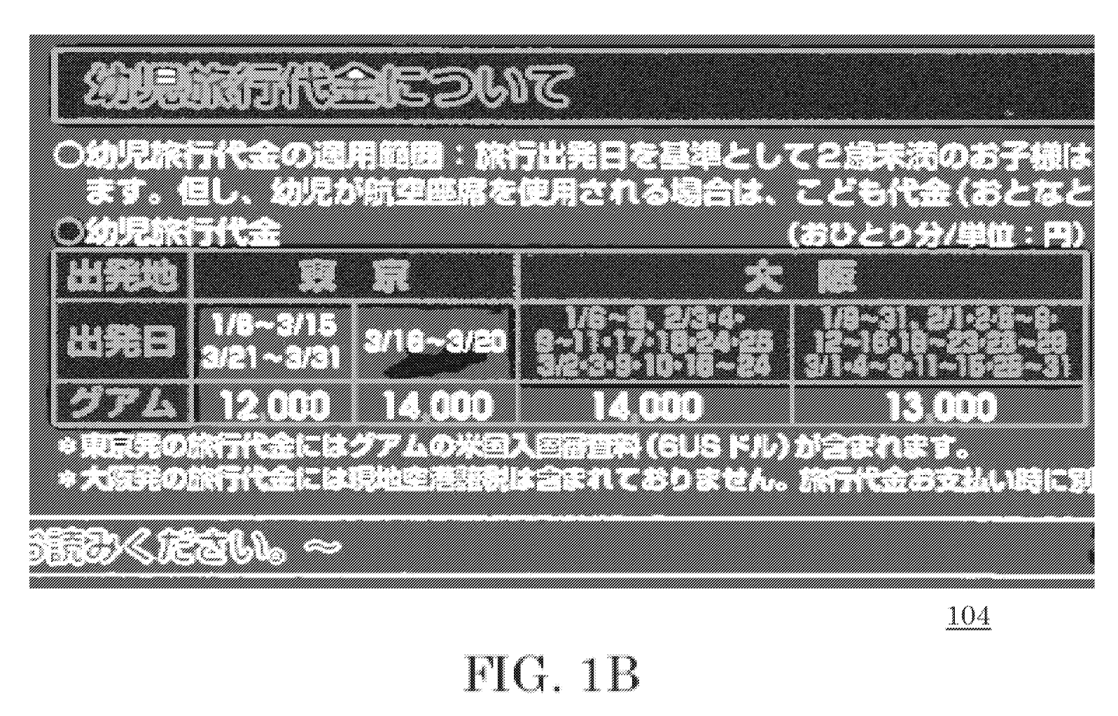

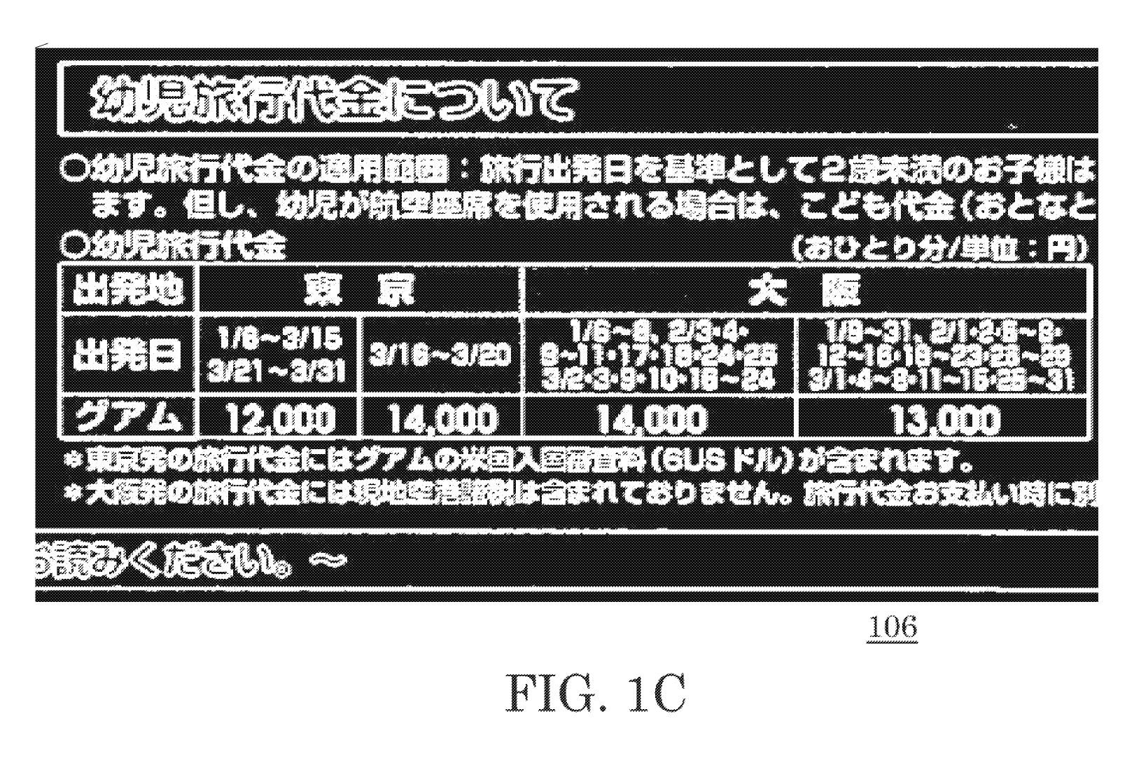

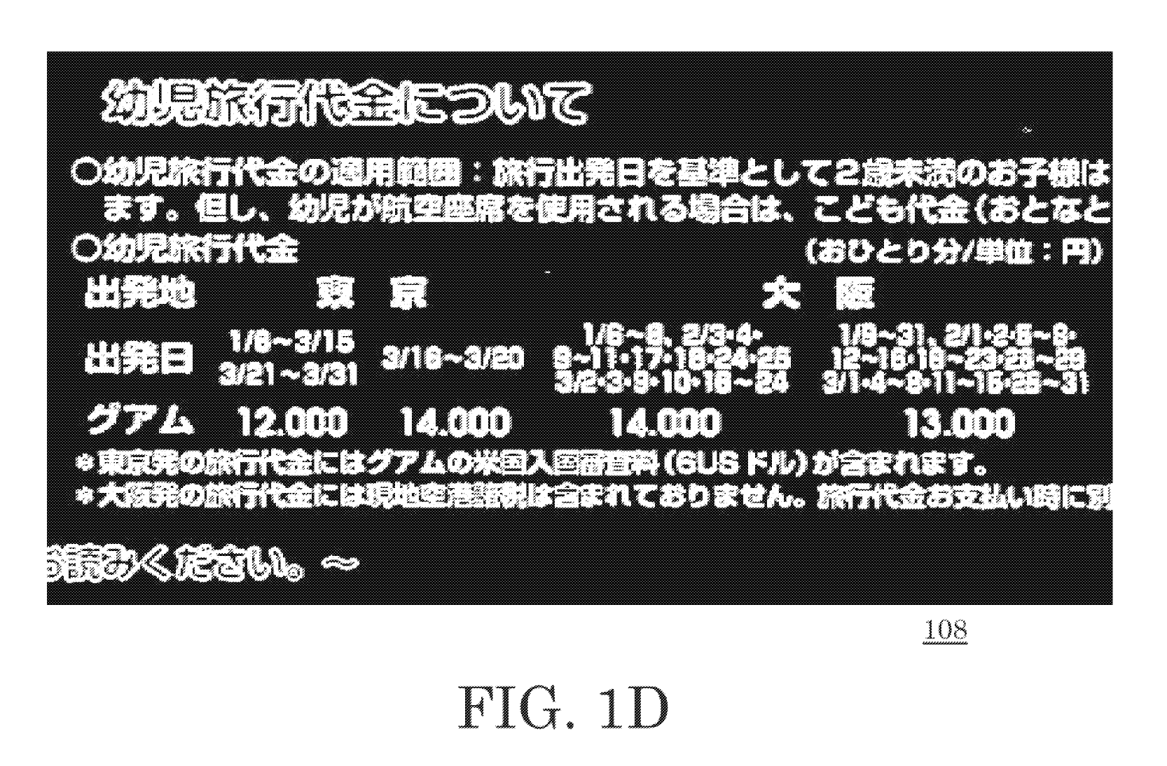

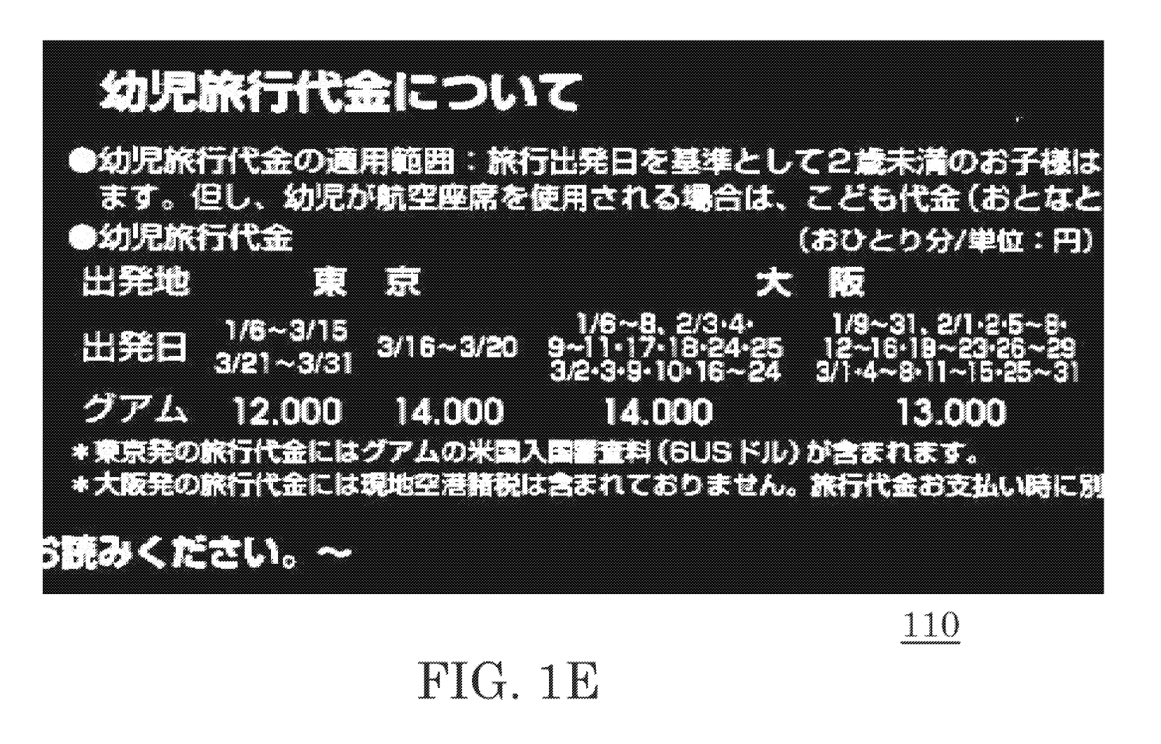

However, when OCR is performed directly on LACE labeled outputs it might not very accurate. For example, the pixel labels on the boundary of characters printed in a large font may be different from the pixel labels within the body of the same characters. Inconsistencies such as this may result in poor OCR performance on documents that include characters printed with large fonts. Additionally, pixels that have been labeled as strong halftone edges, such as pixels that are part of table lines and image boundaries, tend to degrade OCR performance on text characters that contact such lines. An example of a LACE application is illustrated in FIGS. 1A through 1E.

With reference to FIG. 1A, given a scanned document image 102, the LACE labels of the pixels can be computed by identifying foreground pixels and applying connected-components CC, operations on the identified foreground pixels. Preferably, LACE labels are computed as described in U.S. Pat. No. 7,557,963. FIG. 1B is an illustration of the resultant LACE labeled image 104 as computed from image 102. Based on the LACE labels, a first binary image 106, as shown in FIG. 1C may then be constructed where non-halftones and halftone edges are represented as white pixels and other pixels are represented by black pixels. Alternative labeling methodologies that allow foreground pixels to be distinguished from background pixels may be used in place of the LACE labels without going beyond the scope of the present invention.

As an optional subsequent step, strong and long lines, such as characteristic of table lines and image boundaries may be removed, as shown in a second binary image 108 illustrated in FIG. 1D. Text characters can then be identified, as shown in image 110 illustrated in FIG. 1E.

A problem that afflicts text content classification algorithms, in general, however, is the misclassification of text components as non-text components. Thus, a first issue addressed by the present invention is how to identify text components that may have been misclassified as non-text components during the initial pixel identification (i.e. labeling) process. That is, identifying and reclassifying text pixels that were erroneously misclassified as non-text pixels during the initial pixel classification process.

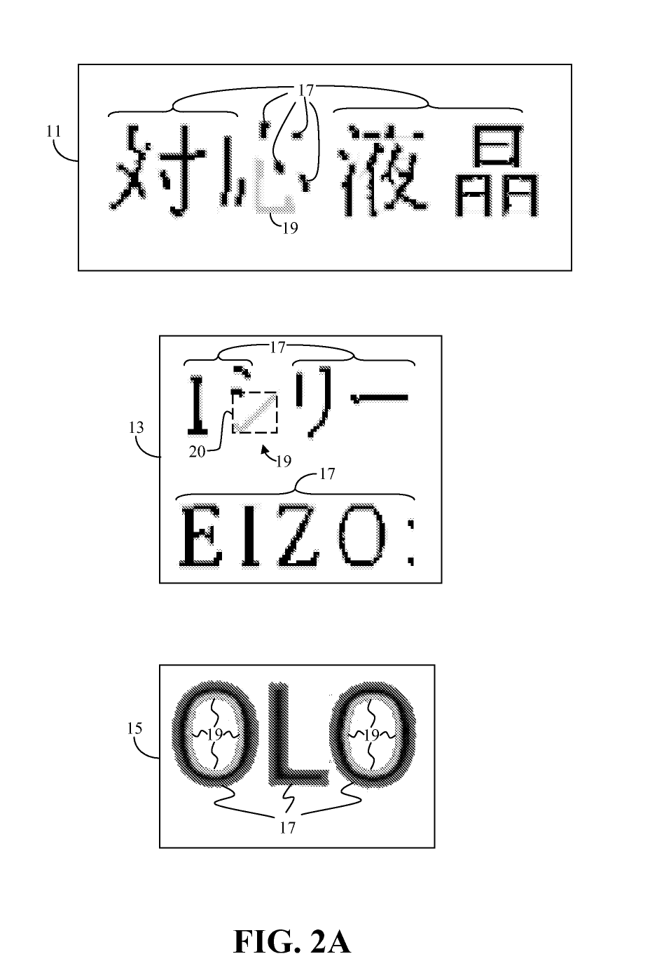

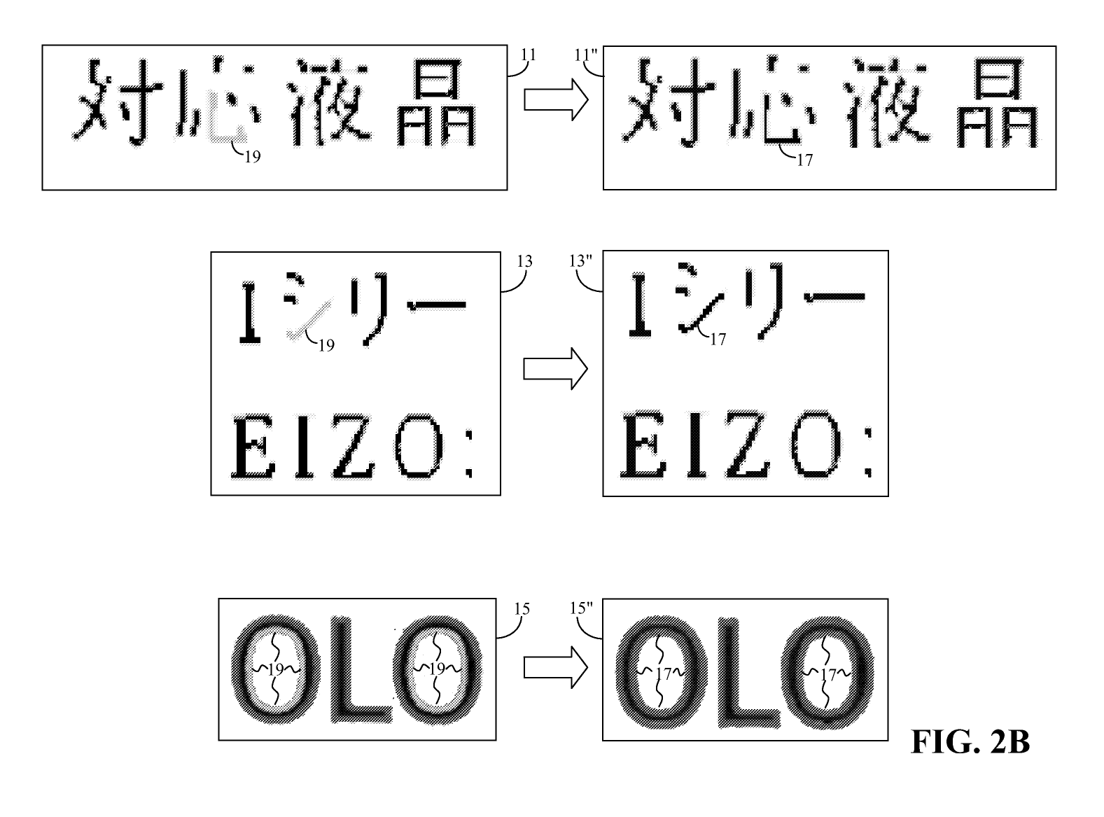

It has been found that often times, misclassified text components are surrounded, or neighbored, by correctly classified text components having similar characteristics, such as size and color, as the misclassified text components. Examples of this are illustrated in FIG. 2A.

With reference to FIG. 2A, three image regions 11 to 15 are shown, each with correctly classified text components 17, generally shown as collections of dark pixels, and misclassified non-text components 19, generally shown as collections of gray pixels. Misclassified non-text components 19 are defined by text pixels that have been incorrectly labeled as non-text pixels. That is, connected component CC structures of text pixels constitute text components, and CC structures of non-text pixels constitute non-text components.

As illustrated, the misclassified non-text components 19 are typically part of a text character and thus are typically surrounded by correctly classified text components 17. In order to identify and correct the misclassified non-text components 19, the present invention attempts to identify components that may be part of a true, but yet unidentified, text character.

To accomplish this, the present invention refines the text content by using information from neighboring components. Basically, non-text components (or pixels) are reexamined to see if they fit a set of criteria, and if they do, then they are reclassified (i.e. relabeled) as text components (or pixels) irrespective of previous processing. Preferably, non-text components are examined and reclassified as text components if they meet the following three criteria:

1) There are at least two other text components nearby. A preferred way of accomplishing this is to identify the dimensions of the bounding block of the non-text components being examined. For example in image region 13, the bounding block of its non-text component 19 is defined as the smallest box that completely encloses its non-text component 19, and in this case is identified as bounding block 20. Any text component 17 that is within a predefined multiple of the dimensions of the bounding block 20 (i.e. preferably within 1.5, or 2, times its dimensions) is deemed to be a “nearby” (or neighboring) text component.

2) Its neighboring text components are approximately aligned horizontally or vertically with the non-text component being examined. Preferably, a neighboring text component is deemed to be approximately aligned with the non-text component being examined if the bounding block of the neighboring text component is aligned within 40% of the horizontal or vertical dimension (as appropriate) of the bounding block of the non-text component being examined.

3) All the identified neighboring text components have similar characteristics as the non-text component being examined. A first example of such a characteristic to be compared is to determined if the identified neighboring text components have a similar (i.e. matching within 40%) average color as the average color of the non-text component. A second example of such a characteristic is to determine if the size of the bounding block of each neighboring text component is within ±40% of the size of the bounding block of the non-text component being examined.

Applying this relabeling technique to the mislabeled components examples of FIG. 2A results in the corrected component classification of FIG. 2B. As shown, the misclassified non-text components 19 of original image region 11 are correctly relabeled as a text component 17 in corrected image region 11″. Similarly, misclassified non-text components 19 of image regions 13 and 15 are correctly relabeled as text components 17 in respective, corrected image regions 13″ and 15″.

Another issue is the problem of non-text pixels being incorrectly labeled as text pixels. This type of misclassification is generally caused by strong half-tone patterns introducing false-detections due to their similarity with groups of small texts (i.e. small text components). This can result in many extemporaneous mislabeled text components being scattered in background areas of a scanned document.

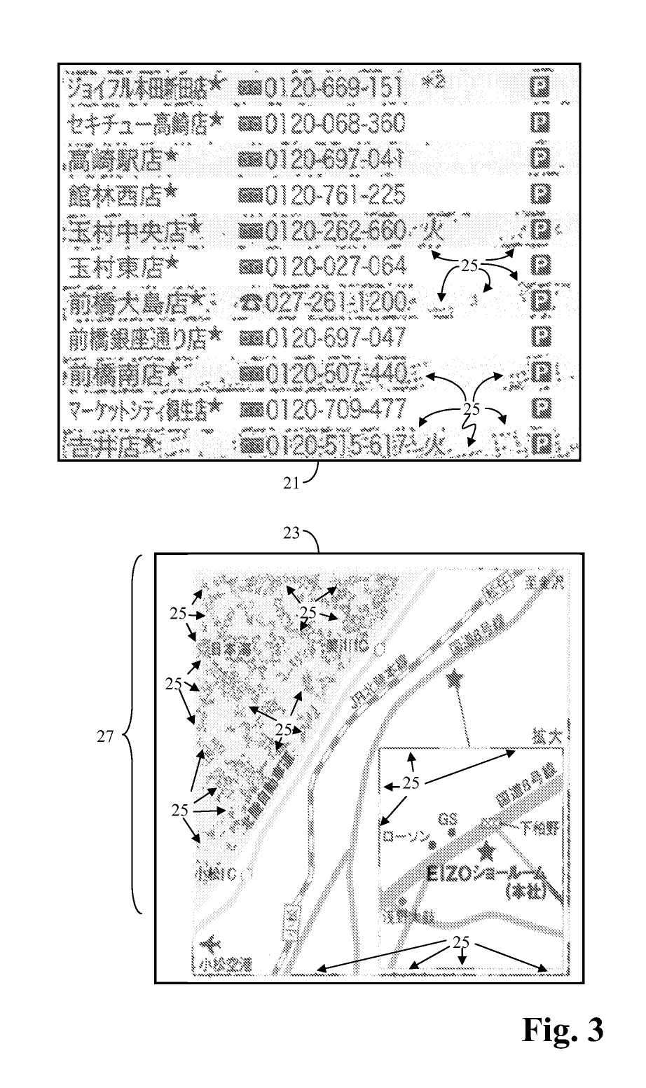

Examples of this are illustrated in image regions 21 and 23 of FIG. 3. Like before, text components are shown as collections of dark pixels. In image region 21, this results in a plurality of dot-like, or smear-like, artifacts 25 scattered throughout the image. Each of artifacts 25 constitutes non-text pixels (i.e. non-text components) misclassified as text pixels (i.e. text components). In image region 23, the mislabeled text components manifest themselves as artifacts 25 scattered throughout background area 27, as well as surrounding foreground regions, at the boundaries between foreground and background areas, and along prominent lines.

A major issue with this type of problem is that the sporadic errors due to half-tones tend to have no definite shape and are thus more difficult to identify than definite structures, such as straight lines. Basically, text classifiers tend to detect strong half-tones as dense groups of small texts (i.e. dense collections of small text components), resulting in the half-tone noise appearing as dense clouds of small dots in a local context.

A first process for addressing this half-tone-related error is by means of what is herein termed a “density filter”. The objective is to identify and filter out the small text components within a local neighborhood that are actually due to half-tone error. This process begins by identifying a text component that is not bigger than a predefined size (i.e., a text component having a bounding box whose width and height dimensions are not greater than a given number(s), for example, ten pixels). The identified text component is herein termed a candidate half-tone component because it might not be a true text component, but rather be due to half-tone error. A local neighborhood is then defined surrounding the candidate half-tone component. Preferably, the local neighborhood is three times the area of candidate half-tone component's bounding box, or a 30×30 pixel area, which ever is greater, surrounding the candidate half-tone component. Next, the number of other text components within the defined local neighborhood that are not bigger than the predefined maximum size is determined. The process also determines the percentage of text pixels to non-text pixels within the local neighborhood. If the percentage of text pixels within the local neighborhood is greater than a predefine percentage (preferably greater than 50%) and the number of text components that are not bigger than the predefined maximum size within the local neighborhood is greater than a predefined minimum number (preferably greater than 4), then all the text pixels (or equivalently all the text components) within the local neighborhood are reclassified as non-text pixels (or equivalently reclassified as non-text components). This process continues until all remaining candidate half-tone components have been filtered.

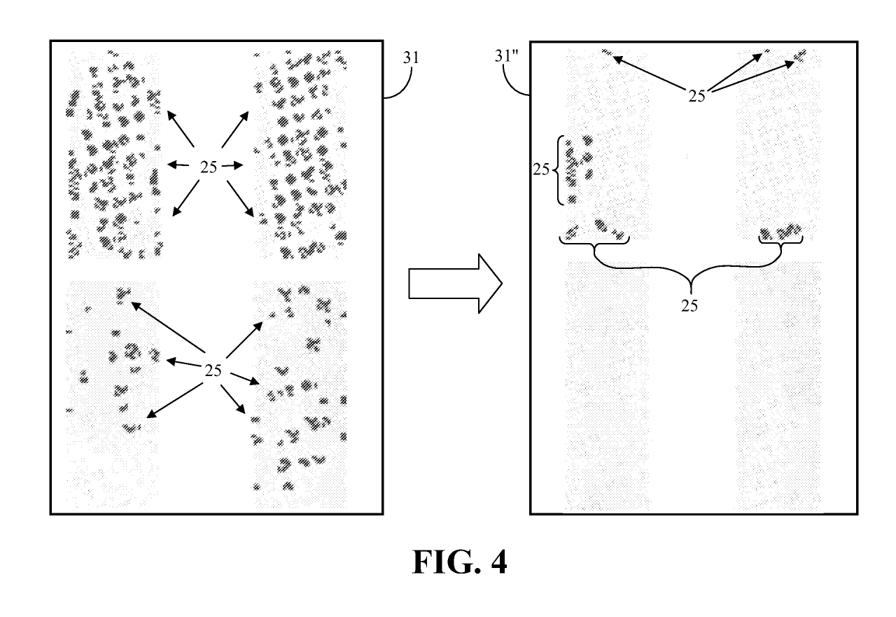

FIG. 4 shows the results of applying a density filter in accord with the present invention to image region 31. As before, the half-tone artifacts (i.e. non-text pixels erroneously labeled as text pixels) are shown as dark pixels 25. Application of a density filter results in corrected image region 31″. As shown, the density filter significantly reduces the number of artifacts 25, but the misclassification of text pixels is not fully corrected. Mislabeled text pixel artifacts 25 remain in corrected image region 31″.

Therefore, a preferred implementation of the present invention applies a preparatory step prior to any text labeling operation such as those explained above, and prior to applying density filtering. The preparatory step creates a guild that indicates the regions of the scanned document to which a text labeling operation should be applied. An objective of this preparatory step is to remove half-tone noise prior to the text labeling operation, but if desired, a density filter may still be applied to the final results. It has been found, however, that the preparatory step may be sufficient to suppress mislabeled pixels due to half-tone errors.

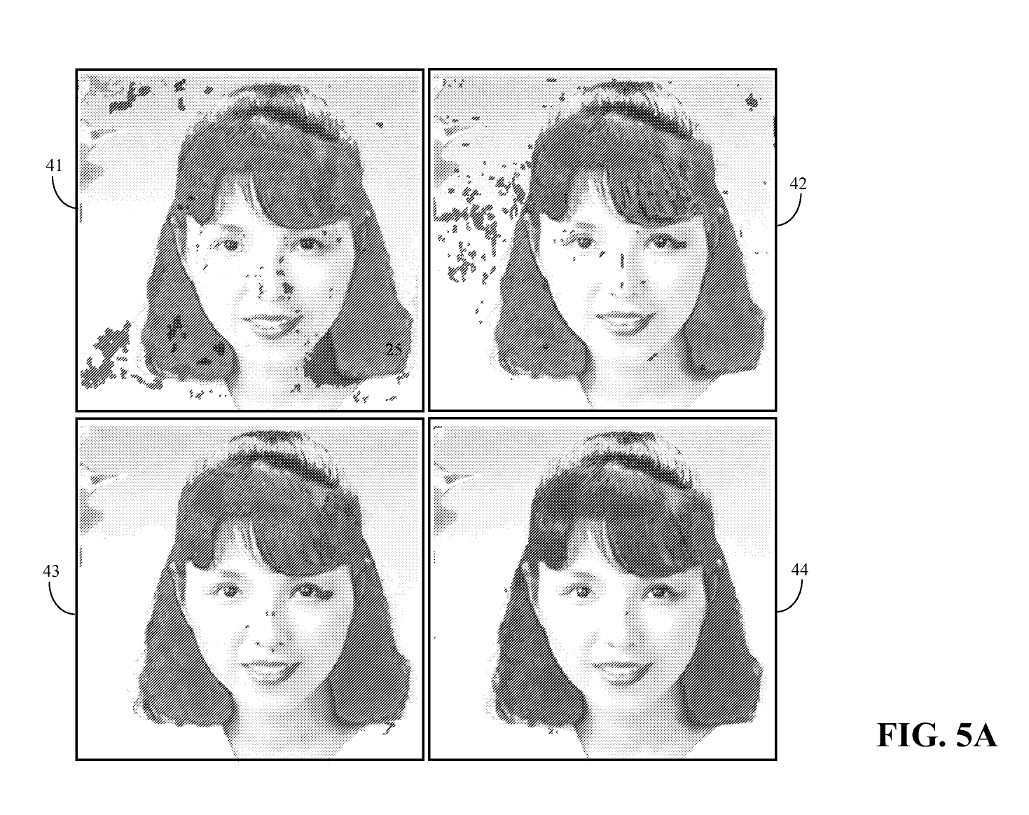

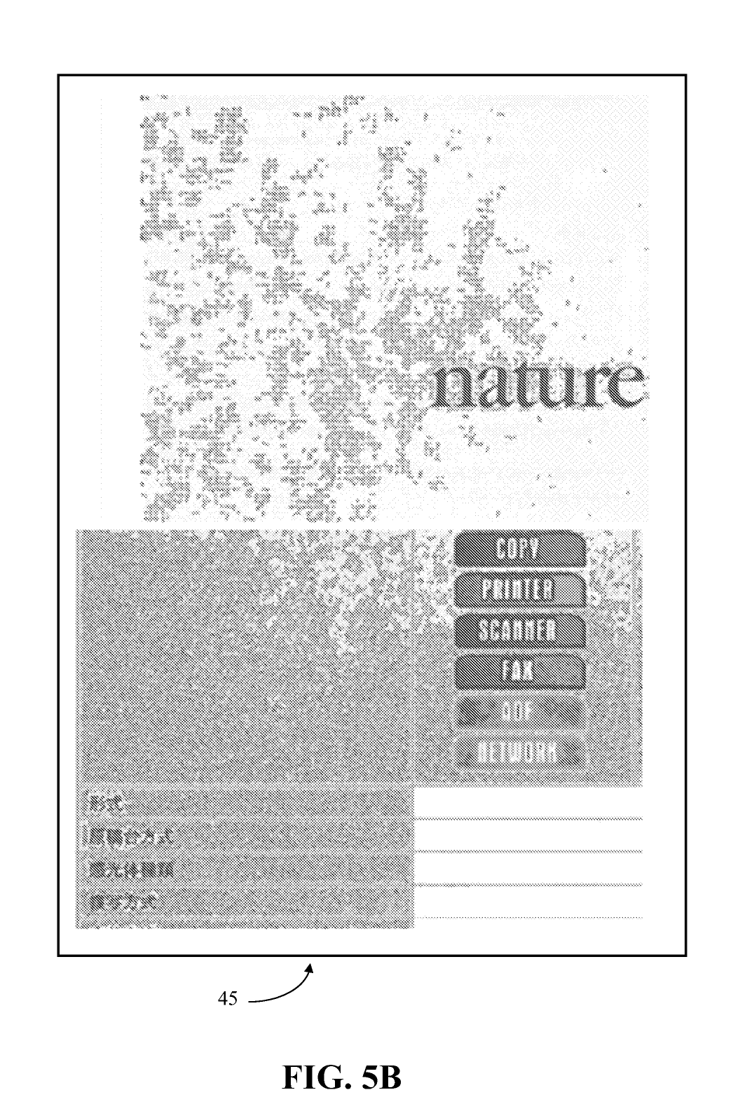

Before explaining this preparatory step, it may be good to introduce a few of the images on which the present invention was tested. FIGS. 5A and 5B illustrate various image regions 41-45 having varying amounts of half-tones. As is explained above, strong half-tone patterns result in false-detected clusters of text pixels (i.e. misclassified text components). As before, mislabeled text pixels are shown as dark pixels. This half-tone-related error is especially evident in image region 45 of FIG. 5B where strong half-tones result in a many mislabeled text pixels in an image that predominantly consists of background areas.

The preparatory step consists of smoothing out the strong half-tone patterns by Gaussian filtering at a local neighborhood, a P×P pixel area (preferably defined as a 7×7 pixel area) around each pixel being processed. In a preferred embodiment, the Gaussian filter is applied to the entire scanned image, such that each pixel is processed, in turn.

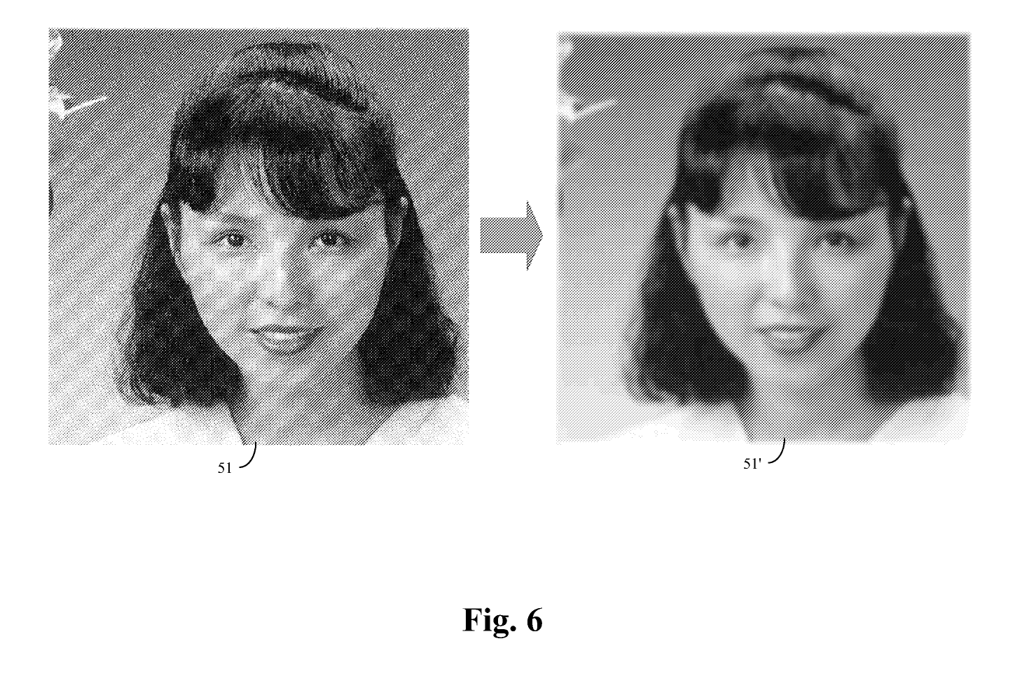

An example is shown in FIG. 6, where a document image 51, which has many strong half-tones as is evident by a strong contrast level, is smoothed preferably by application of a Gaussian filter resulting in smoothed document image 51′.

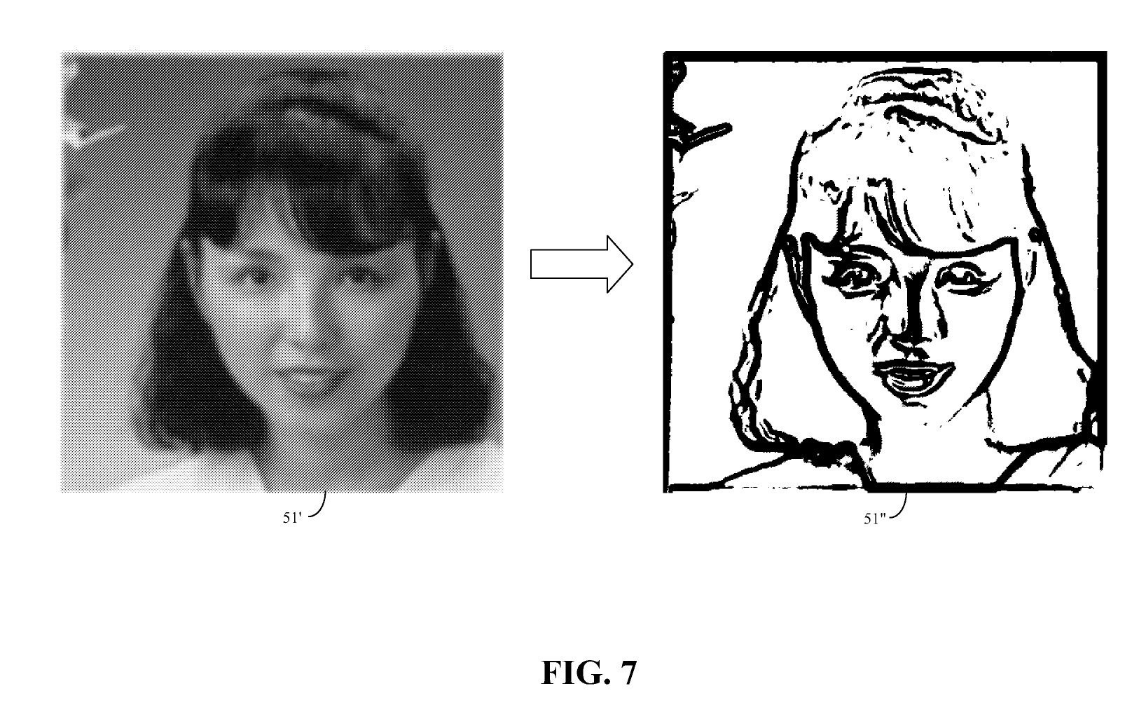

Edge detection is then applied to smoothed document image 51′, as shown in FIG. 7. Any of various edge detection techniques known in the art may be used. Effectively, half-tone noise of original document image 51 (FIG. 6) is cleaned in smoothed document image region 51′ to produce the edge map 51″ (FIG. 7). Edge map 51″ is then used as a guide to determine where to apply the pixel classification operation on the original document image 51. For example, the pixel classification operation (or text labeling operation) may be applied to (i.e. run on) only pixels of document image 51 that correspond to a local neighborhood (i.e. within ±20 pixels) of the smoothed edges defined by edge map 51″.

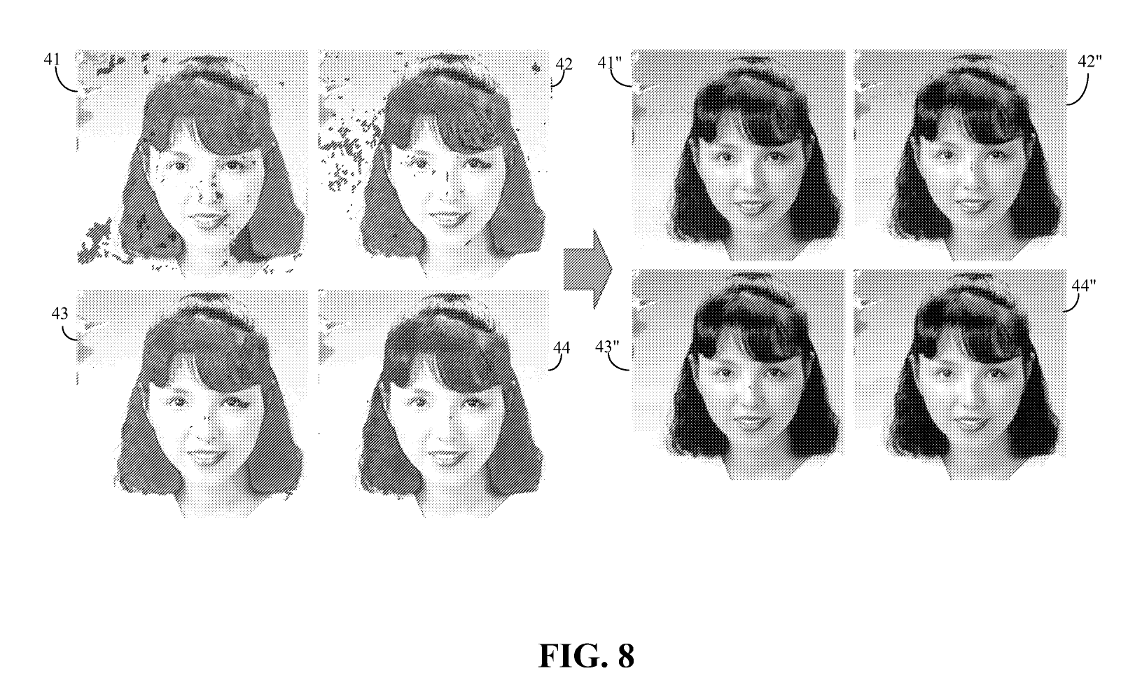

A first example of an application of the present invention is shown in FIG. 8, where it is applied to the image samples 41-44 of FIG. 5A. As shown, the all, or a vast majority of, misclassified text contents of samples 41-44 due to strong half-tone patterns are corrected as non-text contents by the present local neighborhood filtering operation to produce corrected document images 41″ to 44″. If misclassified text content remains, one may apply density filtering, as explained above, to remove any remaining misclassified text content. As it would be understood, the above-describe technique for correcting misclassified non-text components, as described with respect to FIGS. 2A and 2B may be applied to classified text components of corrected document images 41″ to 44″.

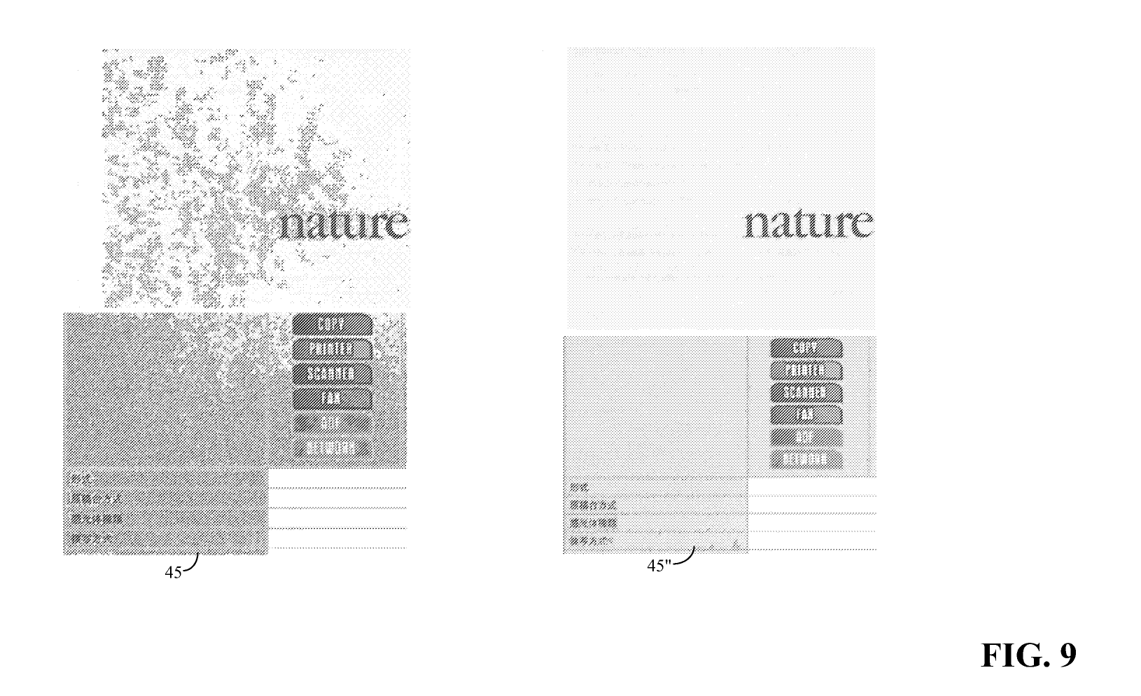

Similarly, a second example of application of the present invention is shown in FIG. 9, where it is applied to image sample 45 of FIG. 5B. Again, the corrected image sample 45″ effectively eliminates most, if not all, of the mislabeled text pixels due to half-tone errors. As before, one may apply density filtering of the small components in the local neighborhood of detected text contents to remove any remaining misclassified text content, and further apply the above-describe technique for correcting misclassified non-text components, as described with respect to FIGS. 2A and 2B.

It is to be understood that the all of the above may be implementing a microcomputer, data processing device or data processor, or other computing device.

While the invention has been described in conjunction with several specific embodiments, it is evident to those skilled in the art that many further alternatives, modifications and variations will be apparent in light of the foregoing description. Thus, the invention described herein is intended to embrace all such alternatives, modifications, applications and variations as may fall within the spirit and scope of the appended claims.

What is claimed is:

1. Method of identifying text components within a document image, said method comprising the following steps:
(a) submitting said document image to a text labeling process to define connected components of foreground pixels within at least a region of said document image and to assign said connected components an initial classification of text component or non-text component as determined by said text labeling process;
(b) for each non-text component,
defining a neighborhood region around the non-text component, where text components within said neighborhood region are termed neighboring text components;
IF there is a predefined number of neighboring text-components, THEN
IF the non-text component meets a predefined set of criteria comparing the non-text component to its neighboring text-components, THEN reclassifying the non-text component as a text component;
ELSE maintaining the non-text component's classification of non-text.

2. The method claim 1, wherein said neighborhood region is defined as an area extending within two times the area of the non-text component's bounding block.

3. The method of claim 2, wherein said set of predefine criteria includes:
determining if the non-text component's bounding block is aligned with the bounding blocks of its neighboring text components within a predefined margin of error.

4. The method of claim 3, wherein said margin of error is 40% of the dimensions of the non-text component's bounding block.

5. The method of claim 1, wherein said predefined number is two.

6. The method of claim 1, wherein said set of predefine criteria includes:
determining if all the neighboring text components have an average color matching the average color of the non-text component within 40%, and if all the bounding blocks of all the neighboring text components having a size within ±40% of the non-text component's bounding block.

7. Method of claim 1, wherein in said step (a), said text labeling process is applied only to areas of said document image coinciding to an edge neighborhood defined as areas of said document image corresponding to a local neighborhood of an edge map.

8. The method of claim 1, wherein said edge map is defined by:
(i) smoothing said document image to create a smooth document image; and
(ii) applying edge detection to said smoothed document image, the resultant detected edges being said edge map.

9. The method of claim 8, wherein said local neighborhood is the area within ±20 pixels of the smoothed edges of said edge map.

10. The method of claim 8, wherein in step (i), said document image is smooth by application of a Gaussian filter.

11. The method of claim 1, further comprising, applying a density filter process after step (a) and prior to step (b), wherein said density filter process includes:
(A) determining if a text component that is not bigger than a predefined size can be identified, the identified text component being termed a candidate half-tone component;
(B) IF no candidate half-tone component is identified, then ending the density filter process;
ELSE:
defining a local neighborhood of minimum size surrounding the candidate half-tone component;
identifying any additional text component within the local neighborhood that are not bigger than the predefined size;
IF the percentage of text pixels within the local neighborhood is greater than a predefine percentage and the number of text components that are not bigger than the predefined size within the local neighborhood is greater than a predefined minimum number, THEN reclassifying all text components within the local window as non-text components;
(C) return to step (A).

12. The method of claim 11, wherein:
the minimum size of the local neighborhood is three times the area of the candidate half-tone component's bounding box or a 30×30 pixel area, which ever is greater;
said predefine percentage 50%; and
said minimum number is 4.

13. A method of identifying text components within a document image, said method comprising:
(i) smoothing said document image to create a smooth document image;
(ii) defining an edge map by applying edge detection to said smoothed document image; and
(iii) submitting select areas of said document image to a text labeling process to assign an initial classification of text component or non-text component to connected components of foreground pixels, wherein said selected areas are defined as coinciding to a local edge neighborhood of said edge map.

14. The method of claim 13, wherein said local edge neighborhood is the vicinity defined within ±20 pixels of the smoothed edges of said edge map.

15. The method of claim 13, wherein in step (i), said document image is smoothed by application of a Gaussian filter.

16. The method of claim 13, further comprising:
(iv) for each non-text component,
defining a neighborhood region around the non-text component, where text components within said neighborhood region are termed neighboring text components;
IF there are at least two neighboring text-components, THEN
IF the non-text component meets a predefined set of criteria comparing the non-text component to its neighboring text-components, THEN reclassifying the non-text component as a text component;
ELSE maintaining the non-text component's initial classification.

17. The method claim 16, wherein said neighborhood region is defined as an area extending within two times the area of the non-text component's bounding block.

18. The method of claim 16, wherein said set of predefine criteria includes:
determining if the non-text component's bounding block is aligned with the bounding blocks of its neighboring text components within a predefined margin of error.

19. The method of claim 18, wherein said margin of error is 40% of the dimensions of the non-text component's bounding block.

20. The method of claim 16, wherein said set of predefine criteria includes:
determining if all the neighboring text components have an average color matching the average color of the non-text component within 40%, and if all the bounding blocks of all the neighboring text components having a size within ±40% of the non-text component's bounding block.
